(19) United States
(12) Patent Application Publication
(10) Pub. No.: US 2007/0166493 A1
(43) Pub. Date: Jul. 19, 2007

(54) Barrier container structure and method of production

(76) Inventors: William J. Cuddihy JR., Northampton, PA (US); Neal E. Langseder, New Cannan, CT (US)

Correspondence Address: Jane Massey Licatn;Licata & Tyrrell P.C., 66 E. Main Street, Marlton, NJ, 08053, US

(21) Appl. No.: 11/623,891

(22) Filed: Jan. 17, 2007

Related U.S. Application Data
(60) Provisional application No. 60/760,161, filed on Jan. 19, 2006.

(51) Int. Cl. B32B 27/08

(52) U.S. Cl. 428/35.7

(57) ABSTRACT

The present invention is a barrier container structure composed of a barrier polymer, such as ethylene vinyl alcohol, blended with poly(ethylene-co-methacrylic acid) ionomer for use in the manufacture of barrier containers for consumer products.

### INTRODUCTION

This application claims the benefit of priority from U.S. provisional application Ser. No. 60/760,161, filed Jan. 19, 2006, which is herein incorporated by reference in its entirety.

### BACKGROUND OF THE INVENTION

Packages for dispensing consumer products are generally made from multiple layers of material which are coextruded to create a thermally bonded laminated construction. A typical barrier container is constructed of five layers: an outer layer of polyethylene, an adhesive bonding layer, a barrier layer, a second adhesive bonding layer, and an inner layer of polyethylene. Other multi-layer materials use seven, nine, or more layers.

A key polymer used in the production of barrier containers with a multilayer construction is ethylene vinyl-alcohol copolymer (EVOH), which is generally approved for food-contact applications. EVOH is resistant to permeation of gases such as oxygen and carbon dioxide, of vapors and of organic liquids including solvents. However, it presents the shortcomings of being moisture sensitive, and having reduced oxygen permeation resistance with increasing relative humidity. Thus, during manufacture, EVOH is generally sandwiched between layers of one or more common polymers such as polyethylene (PE) and polypropylene (PP), which provide water barrier properties but low oxygen permeation resistance to the container.

Multi-layer manufacture techniques typically require multi-layer extrusion dies, additional extruders, and appropriate adhesive layers. Although multi-layer extrusion products satisfy many of the requirements in the packaging industry, they still involve capital investments to purchase the equipment, and require complex process optimization and control.

Polymer blends constitute an alternative to multi-layer extrusion to achieve desirable product properties. They have been used by the plastics industry to meet some stringent requirements of performance and cost. Polymer blends usually include two or more polymers, mixed physically together. Compatible (soluble) blends yield polymer alloys, whereas commercial blends contain incompatible (insoluble) polymers to form a dispersion of one polymer in the other one.

For example, U.S. Pat. No. 5,877,257 teaches three and four component blends of ethylene vinyl alcohol copolymers, ionomer, and nylon for use in packaging films, laminates, co-extrusions and containers prepared therefrom. This references discloses blends of 40 to about 92 EVOH resin, 1 to about 30% amorphous polyamide resin, 2 to about 30% semicrystalline polyamide, and 5 to about 30% ionomer such as of a copolymer of ethylene and methacrylic acid.

Further, U.S. Pat. No. 5,788,890 discloses blending an amorphous polyamide, composed of ethylene vinyl alcohol and amorphous nylon, with an ionomer composed of a copolymer of ethylene and methacrylic acid.

Needed in the art are improved and economical polymer blends which protect consumer products from degradation due to moisture loss or gain, oxygen or carbon dioxide permeation, and fragrance or flavor loss. The present invention meets this long-felt need by providing a barrier container structure composed of a barrier polymer, such as EVOH, dry-blended with poly(ethylene-co-methacrylic acid) ionomer.

### SUMMARY OF THE INVENTION

The present invention is a barrier container structure composed of a barrier polymer and poly(ethylene-co-methacrylic acid) ionomer. In one embodiment, the barrier polymer is from about 5 to about 15 weight percent of the barrier container structure composition. In another embodiment, the poly(ethylene-co-methacrylic acid) ionomer is from about 85 to about 95 weight percent of the barrier container structure composition. A method for producing the barrier container structure of the invention is also provided.

### DETAILED DESCRIPTION OF THE INVENTION

A novel barrier container structure has now been developed for use in container construction. As used herein, the term “barrier container structure” is intended to mean a structure or material for direct use in producing barrier containers. In other words, the structure of the present invention does not require adhesion of additional layers to produce a material suitable for manufacture of a container (e.g., a bottle, squeeze tube, pouch, etc.) with barrier function. In general, the barrier container structure is produced by dry-blending a barrier polymer, such as EVOH, with poly(ethylene-co-methacrylic acid) ionomer and elongating the blend to form a continuous, thin layer of barrier polymer laminated between two layers of poly(ethylene-co-methacrylic acid) ionomer.

For the purposes of the present invention, the barrier polymer and poly(ethylene-co-methacrylic acid) ionomer are generally incompatible polymers in so far as the polymer phases cannot dissolve completely in each other although a certain degree of compatibility exists between the two phases to achieve adhesion at the interface of the two phases without the use of a conventional adhesive. As such, the barrier polymer and poly(ethylene-co-methacrylic acid) ionomer are dry blended using techniques well-known in the art; heated at or near the melting point of the polymers; and elongated by means of conventional equipment such as low shear and low mixing extruders, die lips, pressing rollers or platens, etc. to produce a barrier container structure. If the polymers are obtained in pellet form, the pellets can be melt-extruded, for example, as a film, using procedures well-known in the art. Typically, the thickness of the resulting barrier polymer layer is in the range of 0.01 inch to 0.0001 inch, or desirably approximately 0.001 (±5%) inch. The overall thickness of the barrier container structure is in the range of from about 10 to about 2500 micrometers (0.00039 to 0.098 inch), although thinner and thicker structures may be used.

To achieve the novel laminar polymer of the present invention, particular embodiments provide for blending the barrier polymer and poly(ethylene-co-methacrylic acid) ionomer at a controlled temperature in the range of 180° C. to 280° C., wherein the temperature employed will be dependent upon the barrier polymer selected. For example, when blending polyvinyl alcohol, PETG, or EVOH with poly(ethylene-co-methacrylic acid) ionomer, a temperature in the range of 180° C. to 210° C. is suitable, whereas blending nylon and poly(ethylene-co-methacrylic acid) ionomer may require a temperature in the range of 190° C. to 260° C. The appropriate temperature can be readily determined by one of skill in the art based upon the barrier polymer selected and the melting point thereof. Within the appropriate temperature range, the blend will melt so that it can be formed by stretching and subsequent cooling until it reaches a temperature below the lowest melting point of the blend constituents. The resulting structure is a layer of barrier polymer encapsulated within the poly(ethylene-co-methacrylic acid) ionomer.

Barrier polymers of use in the accordance with the present invention have the general features of preventing moisture loss or gain, oxygen or carbon dioxide permeation, and fragrance or flavor loss. Suitable barrier polymers include, but are not limited to, EVOH, nylon, polyethylene terephthalate glycol (PETG), and polyvinyl alcohol (PVA). In particular embodiments, the barrier polymer is EVOH. EVOH polymers are normally prepared by copolymerization of ethylene with vinyl acetate, followed by hydrolysis of the vinyl acetate component to give the vinyl alcohol group. This process is well-known in the art. An exemplary source of EVOH is EVAL® F171 manufactured by Evalca (Houston, Tex.).

As a thin, internal layer of the barrier container structure, the barrier polymer component is typically employed in an amount ranging from about 5 to about 15 weight percent of the total barrier container structure composition. In particular embodiments, the barrier polymer is about 10 (±1) weight percent of the total barrier container structure composition.

The poly(ethylene-co-methacrylic acid) ionomer can be commercially obtained from a variety of sources; however, a particularly suitable random copolymer of poly(ethylene-co-methacrylic acid) ionomer is SURLYN® ionomer available as pellets and/or films from E.I. du Pont de Nemours & Company (Wilmington, Del.). Exemplary SURLYN® ionomers of use in accordance with the present invention include, but are not limited to, SURLYN® TF90, 7930, 7940, 1601, 8020, 8120, 8140, 8150, 8320, 8527, 8660, 8920, 8940, 8945, 1705-1, 1706, 6101, 9020, 9120, 9150, 9320W, 9520, 9650, 9720, 9721, 9910, 9945, 9950, 9970, PC-100 and the like. The poly(ethylene-co-methacrylic acid) ionomer is typically from about 85 to about 95 weight percent of the total barrier container structure composition. In particular embodiments, the poly(ethylene-co-methacrylic acid) ionomer is about 90 (±1) weight percent of the total barrier container structure composition.

The barrier container structure of the present invention finds application in the production of thermoplastic containers such as tubes, tottles, bottles, pouches, flexible films and other packaging containers which hold consumer products. In particular, the instant barrier container structure is suitable for use in the manufacture of containers designed to protect the package contents from degradation due to moisture loss or gain, oxygen or carbon dioxide permeation, and fragrance or flavor loss. Advantageously, the production of the instant barrier container structure simplifies the equipment necessary for container manufacturing thereby reducing production costs. Further, when using the barrier polymer EVOH in combination with poly(ethylene-co-methacrylic acid) ionomer, it was observed that a bond was created between the EVOH and ionomer such that the structure did not easily delaminate. Moreover, barrier container structure had a consistent, unbroken layer of EVOH near the outer surface of the resulting container structure so that a thicker layer of poly(ethylene-co-methacrylic acid) ionomer was present between the EVOH and the product held within the container. This is preferred because EVOH is hydroscopic and moisture absorbed from the product can reduce the oxygen barrier provided by the EVOH.

The invention is described in greater detail by the following non-limiting examples.

### EXAMPLE 1

### Oxygen Transmission

Using SURLYN® TF90 ionomer (E.I. du Pont de Nemours & Company, Wilmington, Del.) dry-blended with EVAL® F171A EVOH (Evalca, Houston, Tex.) in a 90%/10% ratio, a thin-wall (0.020 inch) tubing was extruded using a monolayer extrusion system. Microscopic analysis of the tubing indicated that the difference in melting point and viscosity of EVOH and SURLYN® forced the EVOH to concentrate in a thin layer near the outer surface of the structure. The resulting barrier container structure had a more consistent EVOH barrier layer than can be realized using SELAR® (hot blended EVOH and adhesive) with polyethylene or polypropylene.

Oxygen transmission rate (OTR) data, a measure of the steady-state rate of transmission of oxygen gas into packages, of several films and coextrusions containing 1 mil EVOH were obtained and compared to virgin SURLYN® and the SURLYN®/EVOH blend. The results of this analysis (Table 1) indicated that the 10% EVOH in SURLYN® significantly decreased the transmission of oxygen through the SURLYN®.

TABLE 1

| Structure | OTR (cc/square meter/day) |
|---|---|
| EVOH Film | 2 to 5 |
| EVOH Coextrusion | 2 to 5 |
| Virgin SURLYN ® | 330 to 340 |
| 10% EVOH in SURLYN ® | 6 to 10 |

What is claimed is:

1. A barrier container structure comprising a barrier polymer and poly(ethylene-co-methacrylic acid) ionomer.

2. The barrier container structure of claim 1, wherein the barrier polymer is from about 5 to about 15 weight percent of the barrier container structure composition.

3. The barrier container structure of claim 1, wherein the poly(ethylene-co-methacrylic acid) ionomer is from about 85 to about 95 weight percent of the barrier container structure composition.

4. A method for producing the barrier container structure of claim 1 comprising blending and elongating a molten barrier polymer and poly(ethylene-co-methacrylic acid) ionomer so that a barrier container structure is produced.
